(19) United States
(12) Patent Application Publication
(10) Pub. No.: US 2020/0232600 A1
(43) Pub. Date: Jul. 23, 2020

(54) Pole Coupling Assembly

(71) Applicant: Dwight Dixon, Yorkville, IL (US)

(72) Inventor: Dwight Dixon, Yorkville, IL (US)

(21) Appl. No.: 16/250,492

(22) Filed: Jan. 17, 2019

(51) Int. Cl. F16M 13/02; A47G 23/02

(52) U.S. Cl. CPC F16M 13/022; A45B 2025/003; A47G 23/0216

(57) ABSTRACT

A pole coupling assembly for coupling an item to a pole includes a block and a ring. The ring is coupled to and extends from a front of the block. A channel extends from a top to a bottom of the block so that the channel is perpendicular to the ring. A void extends into a first side of the block to a distal limit of the channel. The void is transverse to the channel and is configured to insert a substantially vertical pole into the channel. Subsequent pivoting of the block relative to the pole frictionally couples the block to the pole by a force of gravity acting on the ring. The ring is configured to insert an item of the user to couple the item to the pole.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to coupling assemblies and more particularly pertains to a new coupling assembly for coupling an item to a pole.

### BRIEF SUMMARY OF THE INVENTION

An embodiment of the disclosure meets the needs presented above by generally comprising a block and a ring. The ring is coupled to and extends from a front of the block. A channel extends from a top to a bottom of the block so that the channel is perpendicular to the ring. A void extends into a first side of the block to a distal limit of the channel. The void is transverse to the channel and is configured to insert a substantially vertical pole into the channel. Subsequent pivoting of the block relative to the pole frictionally couples the block to the pole by a force of gravity acting on the ring. The ring is configured to insert an item of the user to couple the item to the pole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pole coupling assembly according to an embodiment of the disclosure.

FIG. 2 is a bottom view of an embodiment of the disclosure.

FIG. 3 is a top view of an embodiment of the disclosure.

FIG. 4 is a back view of an embodiment of the disclosure.

FIG. 5 is a side view of an embodiment of the disclosure.

FIG. 6 is a side view of an embodiment of the disclosure.

FIG. 7 is an isometric perspective view of an embodiment of the disclosure.

FIG. 8 is an in-use view of an embodiment of the disclosure.

### DETAILED DESCRIPTION OF THE INVENTION

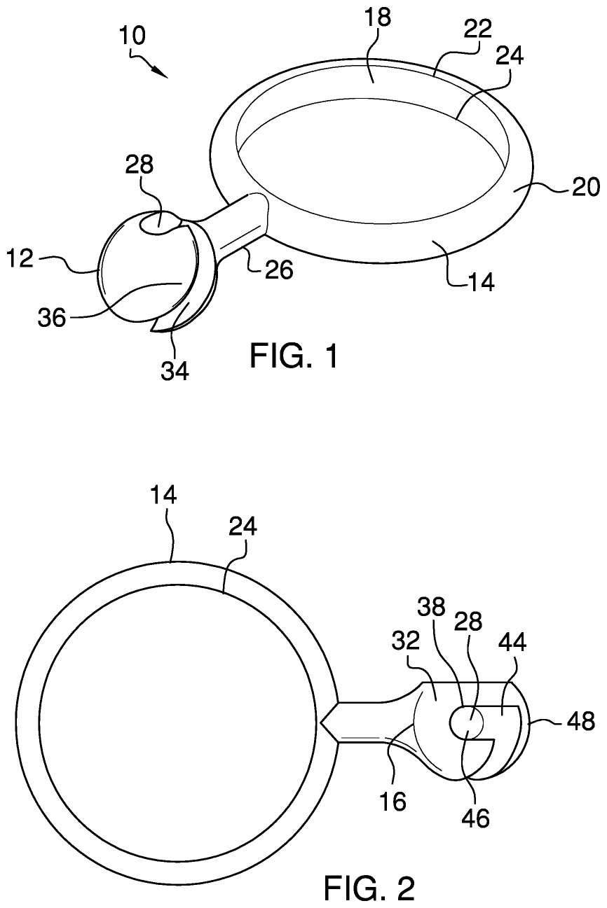

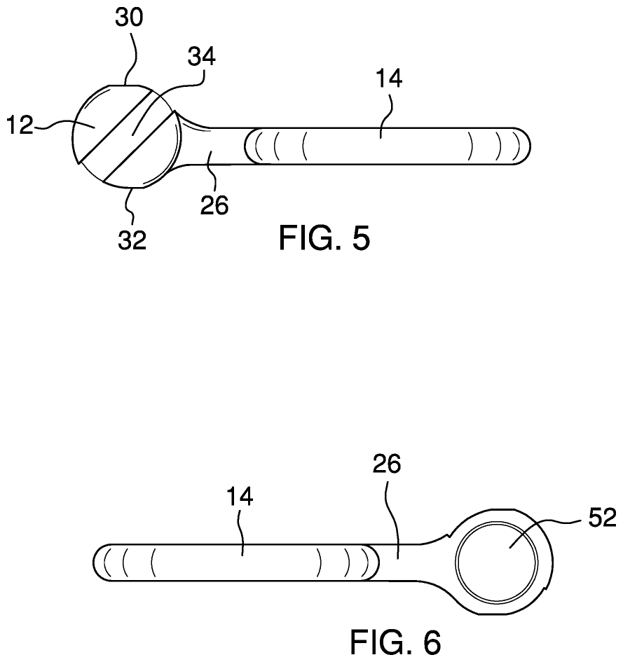

With reference now to the drawings, and in particular to FIGS. 1 through 8 thereof, a new coupling assembly embodying the principles and concepts of an embodiment of the disclosure and generally designated by the reference numeral 10 will be described.

As best illustrated in FIGS. 1 through 8, the pole coupling assembly 10 generally comprises a block 12 and a ring 14. The block 12 is substantially spherically shaped. The ring 14 is coupled to and extends from a front 16 of the block 12.

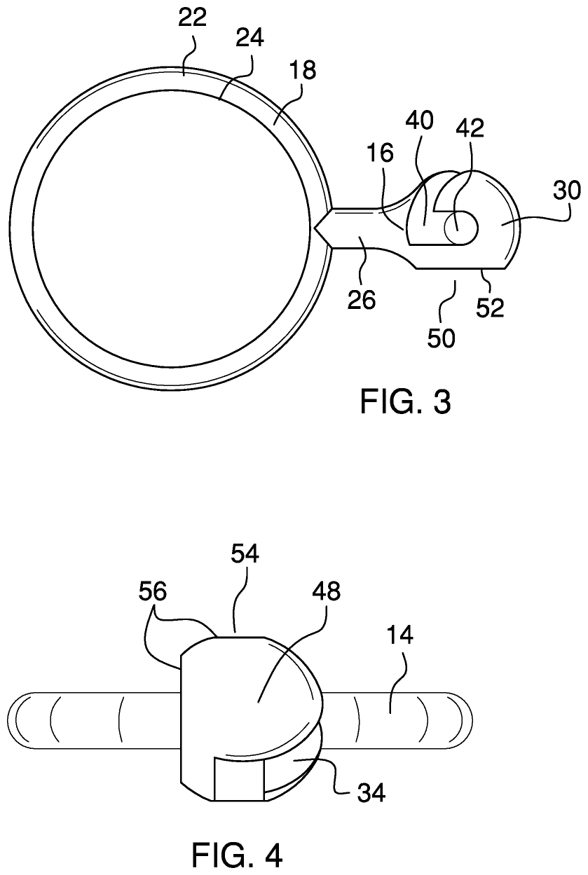

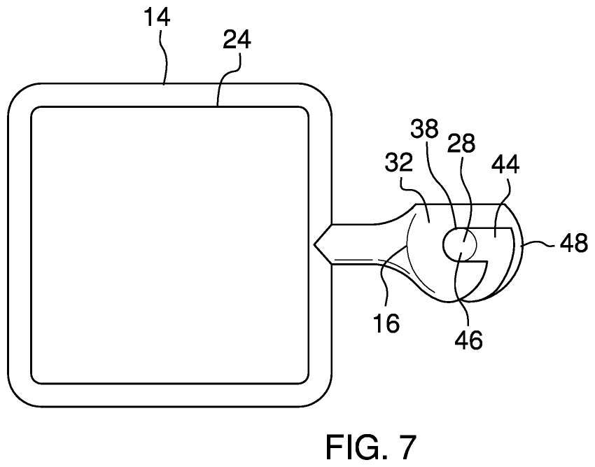

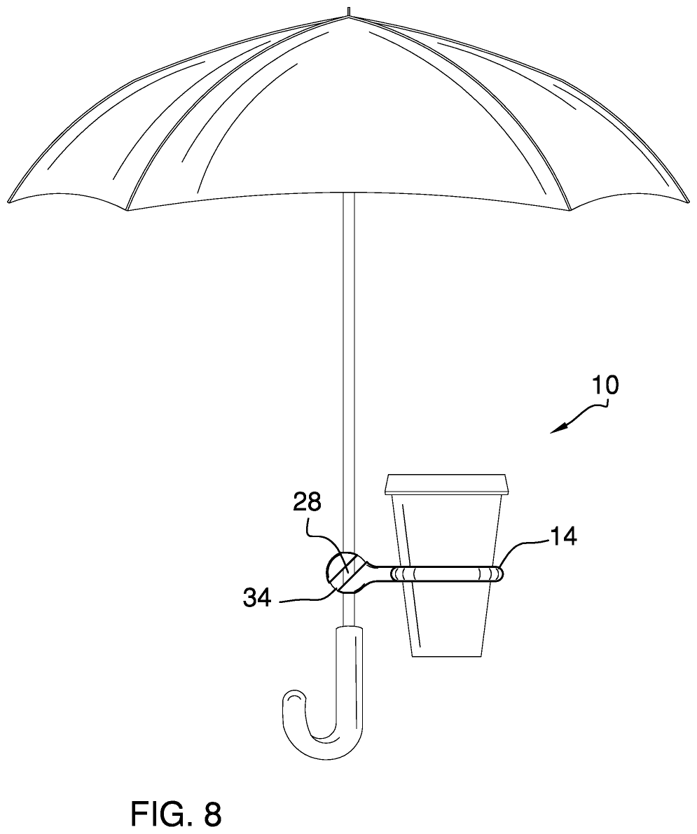

The ring 14 has an inner face 18 that is planar. The ring 14 has an outer face 20 that is convexly arcuate. The inner face 18 has an upper perimeter 22 and a lower perimeter 24. The upper perimeter 22 is circumferentially larger than the lower perimeter 24 so that the inner face 18 is tapered, as shown in FIG. 3. As will become apparent, the tapering of the inner face 18 is conducive to coupling of the ring 14 to a tapered article, such as a coffee cup, as shown in FIG. 8. The ring 14 is substantially circularly shaped. In another embodiment, as shown in FIG. 7, the ring 14 is substantially squarely shaped.

A rod 26 is positioned between the block 12 and the ring 14, as shown in FIG. 2. The rod 26 is circularly shaped when viewed longitudinally. A channel 28 extends from a top 30 to a bottom 32 of the block 12 so that the channel 28 is perpendicular to the ring 14. The channel 28 is centrally positioned through the block 12. The channel 28 is circularly shaped when viewed longitudinally.

A void 34 extends into a first side 36 of the block 12 to a distal limit 38 of the channel 28. The void 34 is transverse to the channel 28 so that an upper end 40 of the void 34 is positioned between an upper opening 42 of the channel 28 and the front 16 of the block 12, as shown in FIG. 3, and so that a lower 44 end of the void 34 is positioned between a lower opening 46 of the channel 28 and a back 48 of the block 12, as shown in FIG. 2. The void 34 is configured to insert a substantially vertical pole into the channel 28, such as a pole of an umbrella as shown in FIG. 8.

Subsequent pivoting of the block 12 relative to the substantially vertical pole frictionally couples the block 12 to the substantially vertical pole by a force of gravity acting on the ring 14. The ring 14 is configured to insert an item of the user, such as a cup of coffee, to couple the item to the substantially vertical pole. The mass of the article serves to increase the frictional coupling of the block 12 to the substantially vertical pole. The rod 26 creates a separation between the item that is positioned in the ring 14 and the substantially vertical pole to facilitate access to the item by the user.

A first cutout 50 is positioned in a second side 52 of the block 12 so that the second side 52 is planar. A second cutout 54 is positioned in the top 30 of the block 12 so that the top 30 is planar. The first cutout 50 and second cutout 54 provide flat surfaces 56 upon which the user may place digits of a hand to manipulate the block 12 to couple the block 12 to, and to decouple the block 12 from, the substantially vertical pole.

In use, the substantially vertical pole is inserted through the void 34 into the channel 28. The block 12 is pivoted relative to the substantially vertical pole to frictionally couple the block 12 to the substantially vertical pole. The item of the user is inserted into the ring 14 to couple the item to the substantially vertical pole.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pole coupling assembly comprising:
a block;
a ring coupled to and extending from a front of the block;
a channel extending from a top to a bottom of the block such that the channel is perpendicular to the ring; and
a void extending into a first side of the block to a distal limit of the channel, the void being angled to the channel wherein the void is configured for inserting a substantially vertical pole into the channel by pivoting the block such that the channel is pivoted less than 90 degrees from vertical to insert the substantially vertical pole into the channel through the void wherein subsequent pivoting of the block relative to the pole frictionally couples the block to the pole by a force of gravity acting on the ring wherein the ring is configured for inserting an item of the user for coupling the item to the pole.

2. The assembly of claim 1, further including the block being substantially spherically shaped.

3. The assembly of claim 1, further including the ring having an inner face, the inner face being planar.

4. The assembly of claim 3, further including the inner face having an upper perimeter and a lower perimeter, the upper perimeter being circumferentially larger than the lower perimeter such that the inner face is tapered.

5. The assembly of claim 3, further including the ring having an outer face, the outer face being convexly arcuate.

6. The assembly of claim 1, further including the ring being substantially circularly shaped.

7. The assembly of claim 1, further including a rod positioned between the block and the ring.

8. The assembly of claim 7, further including the rod being circularly shaped when viewed longitudinally.

9. The assembly of claim 1, further including the channel being centrally positioned through the block.

10. The assembly of claim 1, further including the channel being circularly shaped when viewed longitudinally.

11. The assembly of claim 1, further including an upper end of the void being positioned between an upper opening of the channel and the front of the block, a lower end of the void being positioned between a lower opening of the channel and a back of the block.

12. The assembly of claim 2, further including a first cutout positioned in a second side of the block such that the second side is planar.

13. The assembly of claim 12, further including a second cutout positioned in the top of the block such that the top is planar.

14. The assembly of claim 1, further including the ring being substantially squarely shaped.

15. A pole coupling assembly comprising:
a block, the block being substantially spherically shaped;
a ring coupled to and extending from a front of the block, the ring having an inner face, the inner face being planar, the ring having an outer face, the outer face being convexly arcuate, the inner face having an upper perimeter and a lower perimeter, the upper perimeter being circumferentially larger than the lower perimeter such that the inner face is tapered, the ring being substantially circularly shaped;
a rod positioned between the block and the ring, the rod being circularly shaped when viewed longitudinally;
a channel extending from a top to a bottom of the block such that the channel is perpendicular to the ring, the channel being centrally positioned through the block, the channel being circularly shaped when viewed longitudinally;
a void extending into a first side of the block to a distal limit of the channel, the void being angled to the channel wherein the void is configured for inserting a substantially vertical pole into the channel by pivoting the block such that the channel is pivoted less than 90 degrees from vertical to insert the substantially vertical pole into the channel through the void wherein subsequent pivoting of the block relative to the pole frictionally couples the block to the pole by a force of gravity acting on the ring wherein the ring is configured for inserting an item of the user for coupling the item to the pole, an upper end of the void being positioned between an upper opening of the channel and the front of the block, a lower end of the void being positioned between a lower opening of the channel and a back of the block;
a first cutout positioned in a second side of the block such that the second side is planar; and
a second cutout positioned in the top of the block such that the top is planar.

16. The assembly of claim 15, further including the ring being substantially squarely shaped.
